(19) United States
(12) Patent Application Publication
(10) Pub. No.: US 2020/0400807 A1
(43) Pub. Date: Dec. 24, 2020

(54) Method and Device for Determining the Position of Objects

(71) Applicant: Leibniz-Institut für Festkörper und Werkstoffforschung Dresden e.V., Dresden (DE)

(72) Inventors: Daniil Karnaushenko, Dresden (DE); Oliver Schmidt, Dresden (DE)

(21) Appl. No.: 16/904,559

(22) Filed: Jun. 18, 2020

(30) Foreign Application Priority Data
Jun. 18, 2019 (DE) 102019116526.1

(51) Int. Cl. G01S 13/42

(52) U.S. Cl. CPC G01S 13/42

(57) ABSTRACT

In the field of microelectronics, this concerns a method that can be used to determine the position of objects with improved resolution. The subject of the present invention is to specify a method that is used to determine the position of the objects with high accuracy. The method is achieved according to the invention wherein objects in a medium
either a signal modulated with a code is sent from the component to the object, converted there into a signal modulated with another code and sent to a component,
or a non-code-modulated signal is transmitted from the component to the object, converted there into a signal modulated with a code and sent to a component,
or an object generates a signal modulated with a code and sends it to a component,
   and the noise component of the signal is removed.

### CROSS REFERENCE TO RELATED APPLICATIONS

This application claims the priority of DE 102019116526.1 filed on 2019 Jun. 18; this application is incorporated by reference herein in its entirety.

### BACKGROUND

The invention relates to the field of microelectronics and concerns a method for determining the position of objects that can be used to determine the position of objects on the micrometer scale upwards under various ambient conditions with improved resolution, such as for example objects in gas lines or in vegetable, animal or human fluid circuits, and an apparatus for performing the method.

Various methods are known for magnetic resonance imaging (MR or MRI). Magnetic resonance imaging is an imaging method used in particular in medical diagnosis for the purpose of depicting the structure and function of tissue and organs in the body. In terms of physics, it is based on the principles of nuclear magnetic resonance (NMR) (Wikipedia, headword: Magnetresonanztomographie).

According to U.S. Pat. No. 5,402,786 A, an apparatus for mapping magneto-acoustic resonances of bodies is known, wherein an ultrasonic detector is used in combination with a weak magnetic field and a pulsed radio-frequency generator. Part of the body of a patient is situated in a magnetic field and is exposed to low-frequency acoustic impulses, as a result of which low-frequency waves are generated in the patient, which in turn cause magnetic resonances. The apparatus can be used to easily pinpoint and measure the magneto-acoustic resonances.

A disadvantage of the prior art solutions is that in particular pinpointing objects on the micrometer to nanometer scale in different media is still inaccurate and hence it is possible neither to pinpoint desired locations with sufficient accuracy within the examination time nor to pinpoint and/or transport objects to desired locations within the examination time.

### SUMMARY

The object of the present invention is to specify a method for determining the position of objects, in particular objects on the micrometer to nanometer scale, in a medium that is used to determine the position of the objects with high accuracy and at least within the examination period, and the object is also to specify a simple and inexpensive apparatus for performing the method.

The object is achieved by the invention specified in the claims. Advantageous refinements are the subject of the subclaims, the invention also covering combinations of the individual dependent claims in the spirit of an AND function, provided that they are not mutually exclusive.

### DETAILED DESCRIPTION

The solution according to the invention provides an initial way of specifying a method for determining the position of objects, in particular objects on the micrometer to nanometer scale, in a medium that can be used to determine the position of the objects with high accuracy and at least within the examination period. A simple and inexpensive apparatus for performing this method is similarly known for the first time.

This is achieved by a method for determining the position of objects, wherein objects having at least one linear and/or nonlinear material and/or structural property are introduced into a medium having linear and/or nonlinear properties, the nonlinear material and/or structural properties of the medium not being concordant with the nonlinear material and/or structural properties of the object.

Further, at least one component is arranged outside the medium.

On the basis of the respective linear and/or nonlinear material and/or structural property of the object and of the medium surrounding the object, the invention provides three variants for sending signals to and from the object and processing said signals.

If a signal modulated with a code is transmitted from a component to the object having at least one linear and/or nonlinear material and/or structural property, the signal is converted by the object into another signal modulated with another code and is subsequently sent from the object to at least one component.

If a non-code-modulated signal is transmitted from at least one component to the object having at least one nonlinear material and/or structural property, the signal is converted by the object into a signal modulated with a code and is sent from the object to at least one component.

And finally, if an object having linear and/or nonlinear material and/or structural properties generates a signal modulated with a code, this signal is sent to at least one component.

As soon as a signal modulated with a code has arrived at least one component, the noise component of the signal is removed from said signal and the thus corrected signal is used to ascertain the position of the object in a one-dimensional, two-dimensional or three-dimensional direction with a resolution of <0.1 mm.

The processing of the code-modulated signal in the component can also be referred to as correlation in signal processing, wherein a relationship is formed between two or more temporal or local functions (Wikipedia, headword: Korrelation (Signalverarbeitung)).

The objects pinpointed can be gaseous, liquid or solid objects situated in a gaseous, liquid to solid medium.

By way of example, the objects according to the invention can be pinpointed 2D or 3D structures, such as atoms, molecules, droplets or solid particles in a liquid or in a gas stream, as well as gas bubbles in a liquid, or cancer cells in a human being or a medicament in the bloodstream of a human being or animal or as well as mesoscopic robots or as well as components of all kinds. The objects need to be capable of producing and/or modulating and receiving and/or sending complex signals.

The objects according to the invention are situated in a medium in every case.

According to the invention, it is a requirement for determining a one-dimensional position of an object to involve the arrangement of at least one component, for determining a two-dimensional position of an object to involve the arrangement of at least two components and for determining a three-dimensional position of an object to involve the arrangement of at least three components in each case in the desired dimensional direction in relation to the object, the components each being arranged outside the medium.

All the objects according to the invention have dimensions on the micrometer to nanometer scale and either cannot be pinpointed or cannot be pinpointed with sufficient accuracy and speed using prior art solutions.

The object pinpointing according to the invention relates to pinpointing in a one-dimensional, two-dimensional and/or else three-dimensional direction.

Within the context of the present invention, nonlinear material and structural properties are supposed to be understood to mean that an external excitation, as by means of a magnetic or acoustic field, brings about a response in an object, such as for example temperature changes in the object, expansions of the material of the object or changes in the magnetic properties of the object or structural changes in the object. These changes in the properties of the material and/or of the structure of the object can be one of the nonlinear functions of the external excitation, such as for example a polynomial function, a polyline function or a saturation function or combinations of these. These functions can have a hysteresis.

It is likewise of particular significance according to the invention that, according to the invention, the objects are situated in a medium having linear and/or nonlinear properties, the material and structural properties of which are not concordant with the nonlinear material and/or structural properties of the object. Linear properties within the context of this invention are supposed to be understood to mean the opposite of nonlinear properties, that is to say that an external excitation does not bring about a response in an object, or a response is brought about in the object that does not indicate a response to an external excitation, or a proportional response having a constant proportionality factor in the range of the amplitude of the external excitation.

An advantageous solution according to the invention is if the position of objects having exclusively nonlinear material and/or structural properties is determined and/or the position of objects in media having exclusively linear material and/or structural properties is determined.

Furthermore, it is necessary according to the invention for the objects to receive, modulate and transmit and/or generate and transmit signals, advantageously electromagnetic, acoustic, mechanical or optical signals or waves.

In the case of code-modulated or non-code-modulated signals received by the object, it is of particular significance according to the invention that these are converted by the object into other code-modulated signals. As such, for example received code-modulated or non-code-modulated magnetic signals can be converted into acoustic signals by the object, or received code-modulated or non-code-modulated acoustic signals can be converted into optical signals by the object.

Advantageously, there is a medium present that transmits the signals from and to the object.

The signals received and transmitted by the objects have been transmitted, according to the invention, by at least one component and/or are received by at least one component. The component used can be any technical element that transmits and/or receives signals, advantageously electromagnetic, acoustic, mechanical or optical signals or waves.

Just one component can be used to determine the position of the object in a one-dimensional direction. When there are two or three or more components, the position of the object can be determined in a two-dimensional or three-dimensional direction, the components naturally then each also needing to be arranged in the applicable spatial directions.

After code-modulated signals from the objects have arrived at the component, they are correlated there by virtue of the noise component of the signals being removed and the thus corrected signals being used to ascertain the position of the object in a one-dimensional, two-dimensional or three-dimensional direction with a resolution of in each case <0.1 mm.

Removal of the noise from the received code-modulated signals is necessary according to the invention in order to be able to infer the information about the position of the object from the code-modulated signals transmitted by the objects.

At the same time, the accuracy of the positioning of the objects can be improved further by means of longer signal recording or on the basis of a specific form of the signal, such as for example a phase shift.

The code correlation with the removal of the noise from the signals received at the components is effected as follows, for example.

The code-modulated signal transmitted by the object has a specific form or other unusual qualities as a result of the code modulation. By way of example, the code-modulated signal is modulated with a quasi random noise sequence code. A quasi random noise sequence code of this kind is the Gold code, for example, which is characterized by a high autocorrelation coefficient. Similarly, the cross correlation coefficient between such Gold codes is high. The length of the Gold code in bits, the high autocorrelation coefficient, its uniqueness and the transmission rate (bits/s or chips/s) of the code determine the phase resolution, which, by contrast, determines the position of the object on the basis of the signal propagation speed in the medium.

The higher the autocorrelation coefficient of the code, the higher the value of the cross correlation that can be obtained between the code-modulated signal transmitted by the component and received back by the object. A higher value of the cross correlation of the transmitted code-modulated signal received back by the object in relation to the noise in the signal leads to a more noise-like signal, which means that a high gain coefficient can be ascertained and hence the position of the object can be determined more accurately.

The code for correlating the signals should be modulated and compressed such that a modulation technique, such as phase shift modulation (phase shift keying PSK), amplitude modulation (amplitude shift keying ASK), quadrature amplitude modulation (QAM), frequency modulation (frequency shift keying FSK), can be applied using orthogonal frequency division multiplexing (OFDM) or nonorthogonal frequency division multiplexing (NOFDM), for example.

Such modulation will transmit one or more codes at transmission speeds using a number of carrier frequencies with bandwidths. This is particularly advantageously also usable for ultrasonic techniques, for example, since the phase resolution can be provided by and large in the sub-signal-wavelength range irrespective of the signal length.

The resolution can be improved further, however, if additional digitization is used in the range of the correlation peaks. The higher the autocorrelation coefficient (the height of the peak), the higher the correlation signal of the noise, and the greater the extent to which digitization of the peak is possible.

In such a case, the resolution can be improved to a “sub-bit” or “sub-chip” value after demodulation and data processing. Further improvements can be achieved by the correlation and the phase determination of the frequency carriers.

If the signal is available in the form of a quasi random noise sequence, the influence of the noise caused by the transmission channel will disappear and/or can be eliminated as a result of an appropriate code correlation with an appropriate length and with a sufficiently high autocorrelation coefficient.

However, the code can be designed to be in such a form that the same signal can have different resolutions at the same time.

This is useful for determining the phase shift of an object by means of code ascertainment methods, as a result of which the speed of the position determination method can be improved. However, the requisite code/s can be introduced into the signal (sending by the object or generating by the object), during the nonlinear process combined with interactions between the external excitation (which do not bear the initial code) and the material or the structure of the object.

Further, the apparatus is achieved according to the invention for determining the position of objects, wherein the apparatus consists of an object in a medium and of at least one component arranged outside the medium and of an apparatus for processing code-modulated signals for the purpose of removing the noise component of the signal and for the purpose of ascertaining the position of the object in a one-dimensional, two-dimensional or three-dimensional direction from the corrected signal with a resolution of <0.1 mm.

If there is only one component present, the position of the object can be ascertained, according to the invention, only in a one-dimensional direction. When there are two or more components present in the respective directions, the position of the object can also be ascertained, according to the invention, in a two-dimensional or three-dimensional direction.

This apparatus according to the invention can be used to perform the method according to the invention with all of its advantageous refinements.

The present invention differs from all the prior art solutions in particular in that the signal source is the object whose position is supposed to be determined and that is situated inside a medium, and the position of said object is not obviously determinable in a simpler other manner.

According to the prior art solutions, the position of objects on the micrometer or nanometer scale inside a medium is determinable only up to a local resolution of >0.1 mm. The signal source is arranged outside the medium in this instance. With this type of signal recording, the signal transmitted by a signal source outside the medium and the signal reflected by the object in the medium have the same form, but not the same phase and amplitude. At the same time, undesirable reflections or adsorptions of the medium surrounding the object naturally influence the entering signal in the same manner, which means that the resolution for determination of the location of the object is impaired further as a result.

According to the invention, the object is now the signal source for a code-modulated signal for the first time, which means that neither phase shifts nor undesirable reflections or adsorptions occur or need to be taken into consideration.

According to the invention, the signal source can also be arranged outside the medium, but in these cases too the signals received by the object are modulated and converted, advantageously modulated with a code, and then, according to the invention, have a different form than the signals transmitted by the signal source.

If the object itself transmits a signal, knowledge of the form of the signal is not necessary for the further processing.

By way of example, the signal transmitted by a transmitter is sent to the object, according to the invention, by means of a magnetic field. The object then modulates the received magnetic signal and converts it into an acoustic signal, which then leaves the medium and is received and analyzed and correlated by one or more components. In this way, the undesirable effects of the medium on the transmitted and received signal can be excluded.

By generating different signals having different forms (harmonic, pulsed, noise-like) irrespective of the form of the transmitted signal, it is possible, according to the invention, firstly to avoid undesirable effects by the medium on the signal transmitted by the object and secondly to improve the resolution of the sub-signal-length accuracy to even 1 μm or below.

In the manner according to the invention, it becomes possible to allow the position of objects on the micrometer or nanometer scale in media to be determined with significantly improved accuracy and speed.

### DETAILED DESCRIPTION OF THE PREFERRED EMBODIMENTS

The invention is illustrated in more detail below using multiple exemplary embodiments.

### Example 1

The object consists of a magnetostrictive material and has a specifically designed hysteresis B-H loop as magnetic linear property.

The object is situated in an aqueous solution as a medium having nonlinear properties for the transmission of acoustic waves.

A component, which is both a transmitter of magnetic signals and a receiver of acoustic signals, sends a harmonic magnetic excitation signal, modulated with a wideband code, to the object from outside the medium.

The object receives the wideband magnetic signal and, in response, modulates/converts the wideband magnetic signal into a complex wideband acoustic signal modulated with a Gold code and sends said signal to the component outside the medium.

Since the very unique acoustic Gold code signature is known per se, this signature can be recognized by the receiver component and the phase of the signal modulated with the Gold code can be received and, after the cross correlation/demodulation procedure by the receiver component, determined. Knowledge of the phase of the Gold code allows the signal to be determined very accurately, and the noise in the signal is removed from the signal by means of mathematical relationships known per se.

The presence of a component outside the medium allows the position of the object in one direction to be determined from the signal, after removal of the noise, very accurately with a high resolution of 0.025 mm.

### Example 2

An object comprising a combination of different metallic materials has a magneto-acoustic nonlinear property characterized by a specifically designed hysteresis B-H loop.

The object is situated in a gas stream that has a different nonlinear property than the object.

Three components as transmitters/receivers each send an unmodulated magnetic signal from three positions outside the gas stream in the x, y and z directions.

The object modulates and converts these signals into wideband acoustic signals provided with a signature, so that these signals are provided with the specific signature, and sends these signals to the transmitter/receiver components again.

Knowledge of the modulated signature of the object allows the signal to be recognized very accurately after the cross correlation/demodulation procedure by the receiver components, and the noise in the signal to be removed from the signal by means of mathematical relationships known per se.

The presence of three components outside the medium allows the position of the object in a three-dimensional direction to be determined from the signals, after removal of the noise, very accurately with a high resolution of 0.05 mm.

### Example 3

An object comprising a combination of different metallic materials has an acousto-acoustic nonlinear structural property.

The object is situated in a liquid having linear properties as a medium.

Three components as transmitters/receivers each send an unmodulated acoustic signal from three positions outside the liquid in the x, y and z directions.

The object modulates and converts these signals into wideband acoustic signals provided with a signature, so that these signals are provided with the specific signature, and sends these signals to the transmitter/receiver components again.

Knowledge of the modulated signature of the object allows the signal to be recognized very accurately after the cross correlation/demodulation procedure by the receiver components, and the noise in the signal to be removed from the signal by means of mathematical relationships known per se.

The presence of three components outside the medium allows the position of the object in a three-dimensional direction to be determined from the signals, after removal of the noise, very accurately with a high resolution of 0.01 mm.

### Example 4

A robot as a self-propelled autonomous mesoscopic system, having dimensions in the micrometer range, is situated as an object in a bloodstream as a medium having nonlinear acoustic properties.

The robot generates an acoustic signal modulated with a Gold code signature.

This signal is sent to a component as receiver outside the bloodstream, where it is recognized very accurately as a result of knowledge of the Gold code signature of the robot after the demodulation by the receiver component, and the noise in the signal is removed from the signal by means of mathematical relationships known per se.

The receiver component outside the medium allows the position of the object in a one-dimensional direction to be determined from the signal, after removal of the noise and determination of the signal phase, very accurately with a high resolution of 0.05 mm.

### Example 5

A robot as a self-propelled autonomous mesoscopic system having dimensions in the micrometer range is situated as an object in a bloodstream as a medium having nonlinear optical properties.

The robot generates an optical signal modulated with a signature.

This signal is sent to a component as receiver outside the bloodstream, where it is recognized very accurately as a result of knowledge of the signature of the robot after the demodulation by the receiver component, and the noise in the signal is removed from the signal by means of mathematical relationships known per se.

The receiver component outside the medium allows the position of the object in a one-dimensional direction to be determined from the signal, after removal of the noise and determination of the signal phase, very accurately with a high resolution of 0.005 mm.

1. Method for determining the position of objects, wherein objects having at least one linear and/or nonlinear material and/or structural property are introduced into a medium having linear and/or nonlinear properties, the nonlinear material and/or structural properties of the medium not being concordant with the nonlinear material and/or structural properties of the object, and
either a signal modulated with a code is transmitted from a component to the object having at least one linear and/or nonlinear material and/or structural property and the signal is converted by the object into another signal modulated with another code and is sent from the object to at least one component,
or a non-code-modulated signal is transmitted from at least one component to the object having at least one nonlinear material and/or structural property and the signal is converted by the object into a signal modulated with a code and is sent from the object to at least one component,
or an object generates a signal modulated with a code and sends it to at least one component,
wherein the at least one component is arranged outside the medium, and the noise component of the signal is removed from the signals modulated with a code that arrive at the at least one component, and the thus corrected signal/s is/are used to ascertain the position of the object in a one-dimensional, two-dimensional or three-dimensional direction with a resolution of <0.1 mm.

2. Method according to claim 1, wherein the position of gaseous, liquid or solid objects in a gaseous, liquid to solid medium is determined.

3. Method according to claim 1, wherein the position of objects having dimensions in the mm to nm range, in the form of 2D or 3D structures, is determined.

4. Method according to claim 1, wherein the position of objects having exclusively nonlinear material and/or structural properties is determined.

5. Method according to claim 1, wherein the position of objects in media having exclusively linear material and/or structural properties is determined.

6. Method according to claim 1, wherein the objects transmit electromagnetic, acoustic, mechanical or optical signals and/or convert received electromagnetic, acoustic, mechanical or optical signals into other electromagnetic, acoustic, mechanical or optical signals.

7. Method according to claim 1, wherein determining a one-dimensional position of an object involves the arrangement of at least one component, determining a two-dimensional position of an object involves the arrangement of at least two components and determining a three-dimensional position of an object involves the arrangement of at least three components, the components each being arranged in the desired dimensional direction in relation to the object.

8. Method according to claim 1, wherein there is a medium present that transmits at least the signals from and to the object.

9. Apparatus for determining the position of objects, consisting of an object in a medium and of at least one component arranged outside the medium and of an apparatus for cross correlating code-modulated signals for the purpose of removing the noise component of the signal and for the purpose of ascertaining the position of the object in a one-dimensional, two-dimensional or three-dimensional direction from the corrected signal with a resolution of <0.1 mm.
